(19) United States
(12) Patent Application Publication
(10) Pub. No.: US 2025/0384471 A1
(43) Pub. Date: Dec. 18, 2025

(54) METHOD OF GENERATING COST ESTIMATE

(71) Applicant: Caterpillar Inc., Peoria, IL (US)

(72) Inventor: Tazio Stephan Grivetti, Peoria, IL (US)

(73) Assignee: Caterpillar Inc., Peoria, IL (US)

(21) Appl. No.: 18/746,104

(22) Filed: Jun. 18, 2024

(51) Int. Cl. G06Q 30/0283; G06Q 50/08

(52) U.S. Cl. CPC G06Q 30/0283; G06Q 50/08

(57) ABSTRACT

A method of generating a cost estimate for performing one or more earthmoving operations at a worksite includes receiving, at a controller, a plurality of files indicative of a structural design corresponding to a structure selected from a plurality of structures, a geographical data of the worksite, and at least one operational variable associated with the worksite. The at least one operational variable varies based on the geographical data of the worksite. The method also includes generating, by the controller, at least one of the cost estimate for performing the one or more earthmoving operations at the worksite and an instruction file to autonomously perform the one or more earthmoving operations at the worksite. The cost estimate is displayed to a user.

### TECHNICAL FIELD

The present disclosure relates to a method of generating a cost estimate for performing one or more earthmoving operations at a worksite, a computer-readable medium including computer-executable instructions for executing the method of generating the cost estimate for performing one or more earthmoving operations at the worksite, and a method of generating the cost estimate for performing one or more earthmoving operations at the worksite to autonomously construct a three-dimensional structure at the worksite. The present disclosure additionally relates to transmitting partial or complete machine operation instructions to one or more earthmoving machines to perform and execute the one or more earthmoving operations at the worksite.

### BACKGROUND

Recently, technologies related to constructing structures such as, buildings, houses, and the like using additive manufacturing machines, also referred to as three-dimensional (3D) printing machines, have been developed. Typically, in such cases, a design of the structure may be provided to the 3D printing machine, which may place, deposit, and/or extrude a material to build the structure according to the design.

Before beginning the construction of the structure, one or more earthmoving operations may have to be performed at a worksite at which the structure is to be constructed. Such earthmoving operations may include, for example, levelling, compaction, excavation, and grading. The earthmoving operations are performed by different machines and may require different lead times for execution. Moreover, each earthmoving operation may have an associated cost. Further, the cost of each earthmoving operation may vary, based on, for example, a location of the worksite and dimensions of the structure. It may be favorable for customers to have an up to date information of costs associated with various earthmoving operations at a particular worksite, which may improve decision making and reduce efforts required in calculation of costs for the earthmoving operations at customer end.

KR101775628B1 describes an optimal excavator combination that maximizes construction profit by considering the characteristics of each excavating equipment and work equipment by combining various work tools with excavating equipment, and provides the searched excavator combination information to the operator, thereby providing the optimal excavator combination. It relates to an excavator optimal combination information provision system and a method of setting the optimal excavator combination, which enables a more efficient excavating process through a combination of excavators and improves the productivity of the excavating equipment. The excavator optimal combination information provision system and the excavator optimal combination setting method according to the present invention extract the optimal combination information of the excavating equipment and work equipment that constitutes the excavator using excavation-related information stored in a data storage device, and provide service requested earthwork information. Searches for excavating equipment and work equipment corresponding to the search equipment, sets combination equipment consisting of different combinations of discovered excavating equipment and work equipment, and corresponds to coefficients and motion history according to excavator performance and soil type for each combination equipment. The production volume is calculated based on the cycle time, and each combination equipment is calculated by calculating the difference between the excavation process cost corresponding to the work time, hourly cost, and number of days required for this production volume, and the total earthwork cost calculated from the earthwork information. An excavator combination device that calculates the construction profit for the construction profit and sets the combination equipment with the maximum calculated construction profit as the optimal excavating equipment, and excavator performance information including the engine specifications of the excavating equipment and the maximum digging depth and bucket capacity of the work equipment are stored. A data storage device consisting of an excavator performance table, a motion history table that stores excavator equipment history information about excavator motion, and a soil table that stores soil information including bucket filling coefficients and volume conversion coefficients for each soil type.

### SUMMARY OF THE DISCLOSURE

In an aspect of the present disclosure, a method of generating a cost estimate for performing one or more earthmoving operations at a worksite is provided. The method includes receiving, at a controller, a plurality of files indicative of a structural design corresponding to a structure selected from a plurality of structures, a geographical data of the worksite, and at least one operational variable associated with the worksite. The at least one operational variable varies based on the geographical data of the worksite. The method also includes generating, by the controller, at least one of the cost estimate for performing the one or more earthmoving operations at the worksite and an instruction file to autonomously perform the one or more earthmoving operations at the worksite. The cost estimate is calculated based at least on the structural design corresponding to the structure, the geographical data of the worksite, and the at least one operational variable associated with the worksite. The cost estimate is displayed to a user.

In another aspect of the present disclosure, a computer-readable medium including computer-executable instructions for executing a method of generating a cost estimate for performing one or more earthmoving operations at a worksite is provided. The method includes receiving a plurality of files indicative of a structural design corresponding to a structure selected from a plurality of structures, a geographical data of the worksite, and at least one operational variable associated with the worksite. The at least one operational variable varies based on the geographical data of the worksite. The method also includes generating at least one of the cost estimate for performing the one or more earthmoving operations at the worksite and an instruction file to autonomously perform the one or more earthmoving operations at the worksite. The cost estimate is calculated based at least on the structural design corresponding to the structure, the geographical data of the worksite, and the at least one operational variable associated with the worksite. The cost estimate is displayed to a user.

In yet another aspect of the present disclosure, a method of generating a cost estimate for performing one or more earthmoving operations at a worksite to autonomously construct a three-dimensional structure at the worksite is provided. The three-dimensional structure is selectable from a plurality of files indicative of a structural design. The method includes receiving, at a controller, a geographical data of the worksite and at least one operational variable associated with the worksite. The at least one operational variable varies based on the geographical data of the worksite. The method also includes generating, by the controller, at least one of the cost estimate for performing the one or more earthmoving operations at the worksite and an instruction file to autonomously perform the one or more earthmoving operations at the worksite. The cost estimate is calculated based at least on the structural design corresponding to the three-dimensional structure, the geographical data of the worksite, and the at least one operational variable associated with the worksite. The cost estimate is displayed to a user.

Other features and aspects of this disclosure will be apparent from the following description and the accompanying drawings.

### BRIEF DESCRIPTION OF THE DRAWINGS

FIG. 1A illustrates an exemplary environment in which the present disclosure may be deployed;

FIG. 1B illustrates an exemplary layout of a worksite and an exemplary perimeter of a structure to be constructed at the worksite;

FIG. 2 illustrates an exemplary first display presented on a user interface for generating a cost estimate for performing one or more earthmoving operations at the worksite of FIG. 1B;

FIG. 3 illustrates an exemplary second display including the cost estimate generated by a controller for performing the one or more earthmoving operations at the worksite of FIG. 1B;

FIG. 4 is a flowchart for a process of generating the cost estimate for performing the one or more earthmoving operations at the worksite of FIG. 1B, according to an example of the present disclosure;

FIG. 5 is a flowchart for a method of generating the cost estimate for performing the one or more earthmoving operations at the worksite of FIG. 1B, according to an example of the present disclosure; and

FIG. 6 is a flowchart for a method of generating the cost estimate for performing one or more earthmoving operations at the worksite to autonomously construct a three-dimensional structure at the worksite, according to an example of the present disclosure.

### DETAILED DESCRIPTION

Wherever possible, the same reference numbers will be used throughout the drawings to refer to the same or like parts.

Various structures are now being constructed at worksites using additive manufacturing processes. Before constructing the structures, one or more earthmoving operations are performed at the worksites. Specifically, before building a foundation/footing for the structures, operations such as, levelling, flattening, compaction, excavation, and grading may have to be performed at the worksites. The present disclosure relates to a preparation of the worksites before formation of the foundation and the structures.

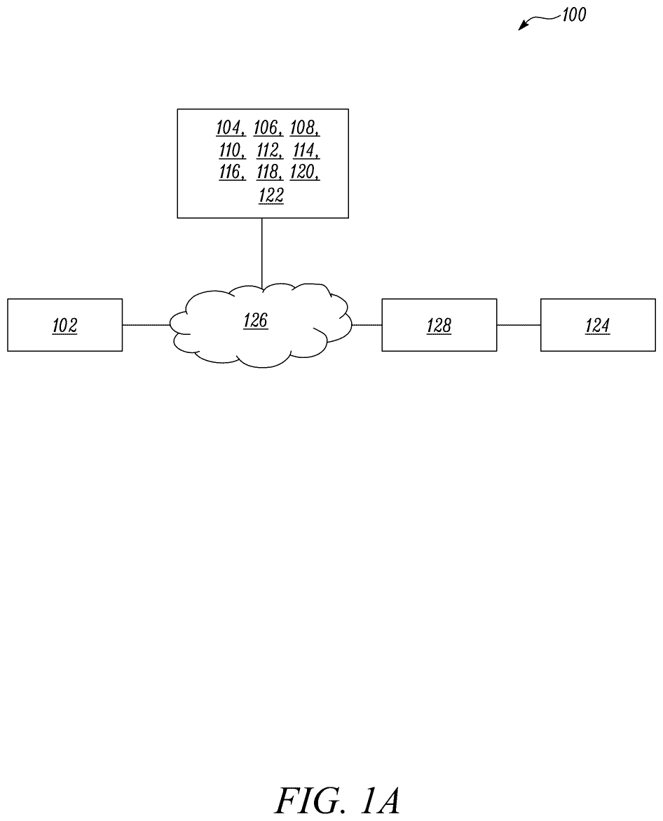

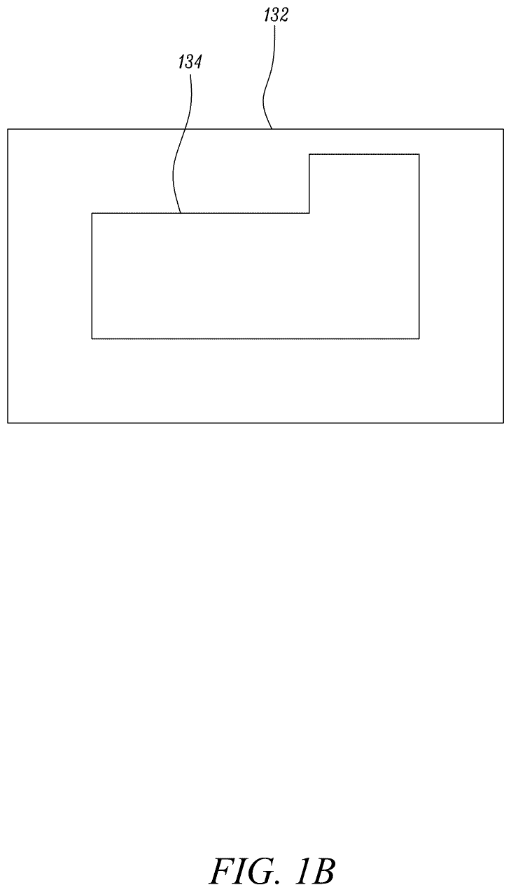

FIG. 1A illustrates an exemplary environment 100 in which the present disclosure may be utilized, according to an example of the present disclosure. It should be noted that FIG. 1A and its associated description provides an exemplary implementation of the present disclosure, and the present disclosure is not limited to the implementation explained in relation to FIG. 1A. The teachings of the present disclosure can be implemented in a number of ways, using different combination of components, control systems, and the like.

As shown in FIG. 1A, the environment 100 includes a user interface 102, one or more databases 104, 106 108, 110, 112, 114, 116, 118, 120, 122, a controller 124, and a communication network 126. The user interface 102, the databases 104, 106 108, 110, 112, 114, 116, 118, 120, 122, and the controller 124 may communicate with each other over the communication network 126.

Examples of the communication network 126 may include, but are not limited to, a wide area network (WAN), a local area network (LAN), an Ethernet, Internet, an Intranet, a cellular network, a satellite network, or any other suitable network for transmitting data. The communication network 126 may be implemented as a wired network, a wireless network, or a combination thereof.

The user interface 102 may include any input/output module that may be used by a user to input information and receive outputs. The user interface 102 may take the form of a computer or a set of computers, although other types of computing units or systems may be used, including laptops, notebooks, handheld computers, mobile devices, set-top boxes, workstations, computer-servers, main frame computers, mini-computers, pervasive computers, network sets of computers, or the like. Further, the controller 124 corresponds to a network portal 128. Users may access the network portal 128 via the user interface 102. The network portal 128 may embody a web page or a web-based service.

Further, the databases 104, 106 108, 110, 112, 114, 116, 118, 120, 122 are in communication with the controller 124, so that the controller 124 may perform one or more operations based on information retrieved from the databases 104, 106 108, 110, 112, 114, 116, 118, 120, 122. The databases 104, 106 108, 110, 112, 114, 116, 118, 120, 122 may employ any kind of database, such as relational, hierarchical, graphical, object-oriented, or other database configurations. Moreover, the databases 104, 106 108, 110, 112, 114, 116, 118, 120, 122 may be organized in any suitable manner, for example, as data tables or lookup tables. Each record may be a single file, a series of files, a linked series of data fields, or any other data structure.

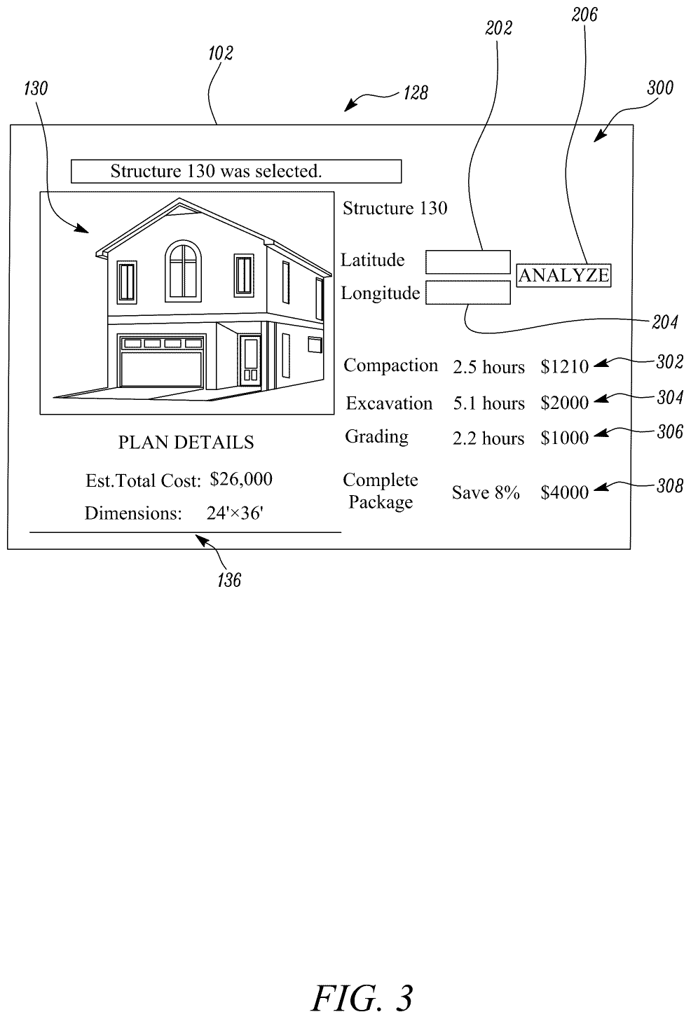

The databases 104, 106 108, 110, 112, 114, 116, 118, 120, 122 store one or more operational variables associated with a worksite 132 (shown in FIG. 1B) at which a structure 130 (shown in FIG. 3) is to be constructed. The structure is embodied as a three-dimensional structure 130 herein. Further, the structure 130 may be hereinafter interchangeably referred to as the three-dimensional structure 130. The structure 130 is embodied as a residential house herein. However, the structure 130 may be of any other type, for example, a commercial building, a shop, a pool, and the like. The structure 130 is to be manufactured by an additive manufacturing process. In an example, the structure 130 may be autonomously constructed, for example, via the additive manufacturing process.

The database 104 is a geographical information system (GIS) database 104. The GIS database 104 may contain data associated with various worksites positioned within a geographic area. Data contained in the GIS database 104 may include absolute or relative positional data associated with various worksites as well as data representative of various attributes of the worksites themselves.

The database 106 is a satellite imagery database 106. The satellite imagery database 106 may store satellite imagery down-linked from one or more orbiting satellites. The satellite imagery database 106 may include not only digital pixel information of the satellite image that is stored but other information such as the angle that a given image was taken at relative to the Earth's surface, satellite ephemeris, sun azimuth, satellite platform orientation, and atmospheric conditions.

The database 108 is a database containing information of a terrain at the worksite 132. More particularly, the database 108 may store information related to a type of the terrain that is present at various worksites. For example, the database 108 may store information regarding whether the terrain at the worksite 132 is rocky, is a dessert, is a mountain, is a plateau, and the like. The database 108 may also include information on the type of soil at various worksites, for example, if the soil is in the form of rocks, dirt, sand, clay, and the like. The database 110 is a frost depth database 110. The frost depth database 110 may store information of frost depth at various worksites. The frost dept may be defined as a depth to which groundwater in soil is expected to freeze. The frost depth depends on the climatic conditions at the worksite 132, heat transfer properties of the soil and adjacent materials, and on nearby heat sources.

The database 112 is an elevation database 112. The elevation database 112 contains information on an elevation at various worksites. The database 114 is a vegetation database 114. The vegetation database 114 may include vegetation details at the worksite 132, for example, types of trees/plants at the worksite 132, the year in which they were planted, and the like.

The database 116 is a database of work machines 116 having a capability to perform the one or more earthmoving operations at the worksite 132. The database 116 may include details of a type of work machine that may be used to perform a particular earthmoving operation based on a size of the worksite 132.

The database 118 is a database of contractors 118 that operate proximal to the worksite 132. The database of contractors 118 may include details of multiple contractors that operate proximal to the worksite 132, jobs that may be undertaken by the contractors, costs associated with the contractors, and the like. The database of contractors 118 may associate materials, components, manpower, or work machines with the earthmoving operations that are needed to prepare the worksite 132.

The database 120 is a database of machine dealers 120 that operate proximal to the worksite 132. The database of machine dealers 120 may include details of multiple machine dealers that operate proximal to the worksite 132, work machines available to rent/purchase at the machine dealers, costs of buying or renting the work machines, and the like. Such machine dealers may repair, sell, or rent work machines or other tools.

The database 122 is a cost database 122 corresponding to a number of previously concluded earthmoving operations proximal to the worksite 132. The cost database 122 may include details related to costs associated with the earthmoving operations that were previously performed proximal to the worksite 132.

It should be appreciated that various functions of the controller 124 may be realized by any number of hardware or software components that perform the specified functions. For example, the controller 124 may employ various integrated circuit components, e.g., memory elements, processing elements, logic elements, look-up tables, or the like, which may carry out a variety of functions under the control of one or more microprocessors or other control devices. Similarly, the software elements of the controller 124 may be implemented with any programming or scripting language with the various algorithms being implemented with any combination of data structures, objects, processes, routines, or other programming elements. Further, it should be noted that the controller 124 may employ any number of conventional techniques for data transmission, signaling, data processing, network control, or the like.

The software elements may be loaded onto a general-purpose computer, a special-purpose computer, or other programmable data processing apparatus, such that the instructions that execute on the computer or other programmable data-processing apparatus create means for implementing the functions of the controller 124. These computer program instructions may also be stored in a computer-readable memory that can direct a computer or other programmable data-processing apparatus to function in a particular manner, such that the instructions stored in the computer-readable memory produce. The computer program instructions may also be loaded onto a computer or other programmable data-processing apparatus to cause a series of operational steps to be performed on the computer or other programmable apparatus to produce a computer-implemented process, such that the instructions that execute on the computer or other programmable apparatus provide steps for implementing various functions.

The controller 124 may include one or more memories and one or more processors. The one or more processors are communicably coupled with the one or more memories. The one or more memories may include any means of storing information, including a hard disk, an optical disk, a floppy disk, ROM (read only memory), RAM (random access memory), PROM (programmable ROM), EEPROM (electrically erasable PROM), or other computer-readable memory media. It should be noted that the one or more processors may embody a single microprocessor or multiple microprocessors for receiving various input signals and generating output signals. Numerous commercially available microprocessors may perform the functions of the one or more processors. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the one or more memories.

In this document, the term “computer-readable medium” may be used to generally refer to media. The media may include a removable storage drive, a hard disk installed in a hard disk drive, and the like. In an example, the computer-readable medium may be a software on a non-transitory medium, such as a CD-ROM. In another example, the computer-readable medium may be a software embedded in a website. In yet another example, the computer-readable medium may be provided to a third party in an application programming interface (API) that can be individually licensed for inclusion in the third party's website or other media. The computer-readable medium may provide software to the controller 124. In some examples, the computer-readable medium may be executed by the processor of the controller 124. The present disclosure is further directed to the computer-readable medium.

The controller 124 receives a number of files indicative of a structural design corresponding to the structure 130 selected from the number of structures. It should be noted that the user accesses the network portal 128 to select the structure 130 from the number of structures. Further, the structural design of the structure 130 includes a perimeter 134 (shown in FIG. 1B) of the structure 130 and a weight of the structure 130. In one example, the memories of the controller 124 may store the number of files indicative of the structural design corresponding to multiple structures. Further, based on the selection of the structure 130 by the user, the processors of the controller 124 may retrieve, from the memories, the structural design corresponding to the structure 130 that is selected by the user.

The controller 124 further receives a number of files indicative of a geographical data of the worksite 132. Further, the user provides the geographical data of the worksite 132 via the user interface 102. In some examples, the geographical data of the worksite 132 includes a latitude and a longitude of the worksite 132. The controller 124 further receives a number of files indicative of one or more operational variables associated with the worksite 132. The one or more operational variables vary based on the geographical data of the worksite 132. Further, the one or more operational variables associated with the worksite 132 includes a cost criterion, the terrain at the worksite 132, and/or one or more land conditions at the worksite 132. Furthermore, the one or more operational variables associated with the worksite 132 may include temperature or weather conditions at the worksite 132 during the entire year, which may dictate a foundation/footing for the structure 130. The operational variables may also include a depth to which the worksite 132 may have to be dug to form the foundation for the structure 130, based on the geographical data of the worksite 132. For example, at a first geographical location, the requirements may dictate that the foundation should be 3 feet below a ground level, and at a second geographical location the requirements may dictate that the foundation should be 3.5 feet below the ground level.

The cost criterion may relate to the cost of preparing the worksite 132. For example, the cost criteria may consider the cost of materials, labor costs, the cost of equipment rental, work machines, or tools, and the like. The cost criteria may factor in differences in cost based on at least the geographical data of the worksite 132. The cost criteria may factor in shipping costs. The cost criteria may include overall quality of the design. Designs that are meant to last for decades, for example, may have better quality criteria than designs for structures that will not last as long under the same conditions. Any methodology for determining and weighing factors that may be directly or indirectly related to cost associated with the worksite 132 may be considered in determining the cost criteria of preparing the worksite 132.

Further, the one or more land conditions may include vegetation details at the worksite 132, type of terrain at the worksite 132, types of soils at the worksite 132, the frost depth at the worksite 132, the elevation at the worksite 132, and the like.

It should be noted that the controller 124 receives the number of files indicative of the one or more operational variables from the GIS database 104, the satellite imagery database 106, the database 108 containing information of terrain at the worksite 132, the frost depth database 110, the elevation database 112, and/or the vegetation database 114. The files retrieved from the database 108, the GIS database 104, the satellite imagery database 106, the vegetation database 114, and the elevation database 112 may provide details regarding presence of trees, types of terrain, soil types, a flatness/elevation, presence of water bodies at the worksite 132, and the like. The files retrieved from the frost depth database 110 may provide details regarding how deep the foundation needs to be placed to confirm with the frost depth regulations at the worksite 132.

Further, the controller 124 receives the number of files indicative of the one or more operational variables from the database of work machines 116 having the capability to perform the one or more earthmoving operations. The files retrieved from the database of work machines 116 may provide details regarding the types of work machines that may be required to prepare the worksite 132, their sizes, their capabilities, their costs, and the like. Moreover, the controller 124 also receives the number of files indicative of the one or more operational variables from the database of contractors 118 that operate proximal to the worksite 132, the database of machine dealers 120 that operate proximal to the worksite 132, and the cost database 122 corresponding to the number of previously concluded earthmoving operations proximal to the worksite 132.

The files retrieved from the database of contractors 118 may provide details regarding an availability of various contractors proximal to the worksite 132, services provided by the contractors, manpower details, their costs, and the like. The files retrieved from the database of machine dealers 120 may provide details regarding an availability of various approved machine dealers proximal to the worksite 132, work machines that are available for rent/purchase with the machine dealers, costs associated with renting/purchasing of the work machines, and the like. The files retrieved from the cost database 122 may provide details related to costs associated with previously performed earthmoving operations that were performed proximal to the worksite 132.

The controller 124 may also receive the number of files indicative of the one or more operational variables from a local nuances database that includes specific requirements that are local to the worksite 132. The files retrieved from the local nuances database may provide details related to any specific requirements at the worksite 132. It should be further noted that the operational variables that have an impact on efforts required to prepare the worksite 132 may be received from any other type of database that are not mentioned herein, as per application requirements.

Further, the controller 124 generates a cost estimate for performing the one or more earthmoving operations at the worksite 132. The cost estimate is calculated based at least on the structural design corresponding to the structure 130, the geographical data of the worksite 132, and the one or more operational variables associated with the worksite 132. The cost estimate is displayed to the user. Specifically, the controller 124 generates and transmits the cost estimate to the user interface 102. Further, the user interface 102 displays the cost estimate thereon.

Furthermore, the controller 124 also generates an instruction file to autonomously perform the one or more earthmoving operations at the worksite 132. The instruction file is in a predefined format. The predefined format enables processing of the instruction file to autonomously perform the one or more earthmoving operations at the worksite 132. Further, one or more work machines may be employed to execute the instruction file to autonomously perform the one or more earthmoving operations at the worksite 132. The instruction file may be directly sent to a work machine, such as, a compactor, an excavator, a motor grader, and the like to autonomously prepare the worksite 132.

In some examples, the controller 124 may be used to generate a cost estimate for digging a hole for a pool at the worksite 132 or to add fine grading for immediate landscaping, without any limitations.

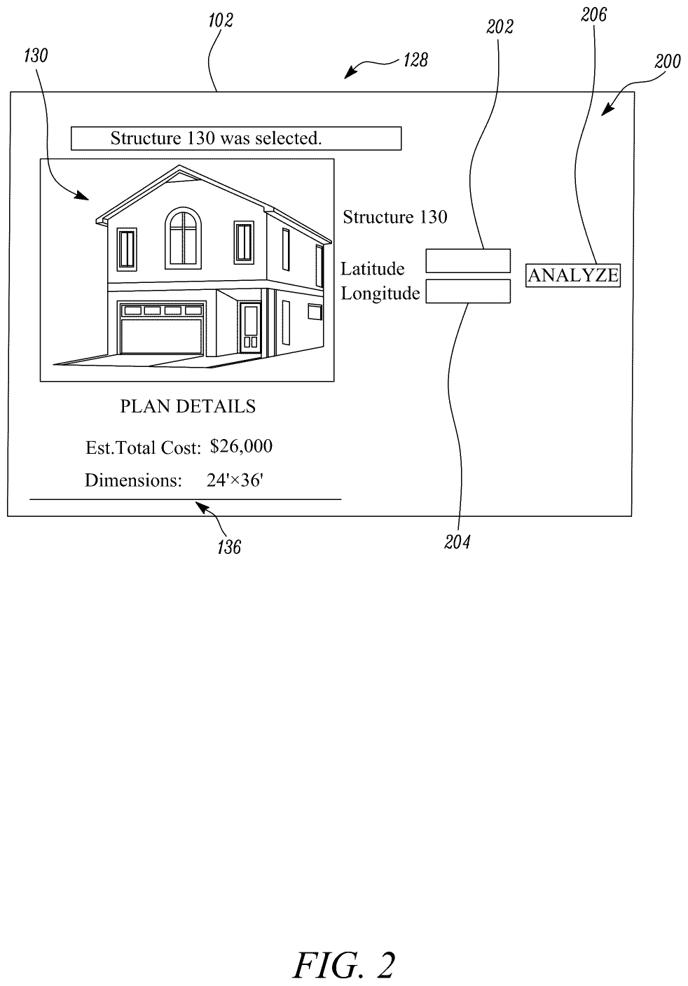

FIG. 2 illustrates an exemplary first display 200 presented on the user interface 102. The first display 200 is associated with the network portal 128. The user may access the network portal 128 and navigate to the first display 200. The first display 200 is presented on the user interface 102 after the user has selected the structure 130. In the first display 200 illustrated in FIG. 2, the user has selected the structure 130 that will be constructed at the worksite 132 (see FIG. 1B) by the additive manufacturing process.

The first display 200 also includes plan details 136, i.e., estimated cost of constructing the structure 130, the perimeter 134 of the structure 130, and the like. Further, the first display 200 includes a first input tab 202 to enter the latitude of the worksite 132 and a second input tab 204 to enter the longitude of the worksite 132. Once the user enters the latitude of the worksite 132 and the longitude of the worksite 132, the user clicks on a third input tab 206. The clicking on the third input tab 206 causes the controller 124 (see FIG. 1A) to generate the cost estimate and the instruction file.

FIG. 3 illustrates an exemplary second display 300 presented on the user interface 102. The second display 300 is associated with the network portal 128. The second display 300 is displayed on the user interface 102 after the user clicks on the third input tab 206 (see FIG. 2). As shown in FIG. 3, the second display 300 provides the cost estimate and a time required for each earthmoving operation. Specifically, the second display 300 includes a first output 302 that provides the cost estimate and the time required to perform a compaction operation at the worksite 132 (see FIG. 1B). The first output 302 may also display a type of work machine that may be used to perform the compaction operation.

Further, the second display 300 includes a second output 304 that provides the cost estimate and the time required to perform an excavation operation at the worksite 132. The second output 304 may also display a type of work machine that may be used to perform the excavation operation. Furthermore, the second display 300 includes a third output 306 that provides the cost estimate and the time required to perform a grading operation at the worksite 132. The third output 306 may also display a type of work machine that may be used to perform the grading operation. Moreover, the second display 300 includes a fourth output 308 that provides the cost estimate for executing a complete package of the compaction operation, the excavation operation, and the grading operation at the worksite 132. It should be noted that the first output 302, the second output 304, the third output 306, and the fourth output 308 may include any other information that may provide information to users regarding the earthmoving operations that are to be performed at the worksite 132.

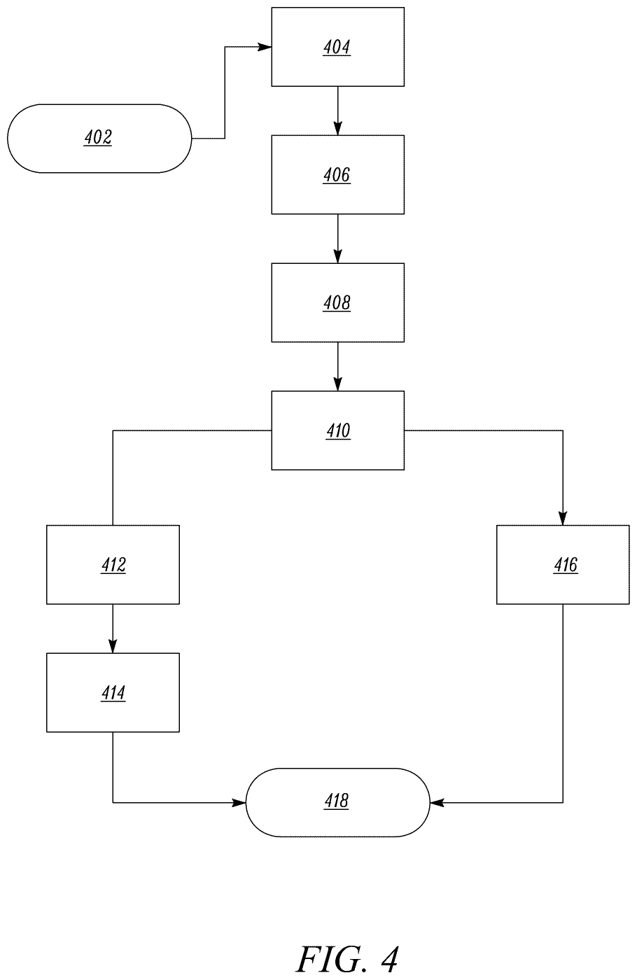

FIG. 4 illustrates a flowchart (or an algorithm) for a process 400 of generating the cost estimate and the instruction file to perform the one or more earthmoving operations at the worksite 132. The process 400 is implemented by the controller 124 illustrated in FIG. 4. Referring to FIGS. 1 and 4, the process 400 may be stored in the one or more memories of the controller 124 and retrieved for execution by the one or more processors of the controller 124.

The process 400 starts at a block 402. Further, at a block 404, the controller 124 receives the details of the structure 130 selected by the user, via the network portal 128. At a block 406, the controller 124 retrieves the files indicative of the structural design corresponding to the structure 130 selected by the user. At a block 408, the controller 124 receives the geographical data of the worksite 132. Specifically, the controller 124 receives the latitude and longitude of the worksite 132 from the user, via the network portal 128. At a block 410, the controller 124 receives the one or more operational variables associated with the worksite 132 from the databases 104, 106 108, 110, 112, 114, 116, 118, 120, 122, based on the geographical data of the worksite 132.

Further, at a block 412, the controller 124 generates the cost estimate for performing the one or more earthmoving operations at the worksite 132 based on the structural design corresponding to the structure 130, the geographical data of the worksite 132, and the one or more operational variables associated with the worksite 132. At a block 414, the controller 124 transmits the cost estimate to the user interface 102 to display the cost estimate to the user. From the block 410, the process 400 also moves to a block 414 at which the controller 124 generates the instruction file that is used to autonomously perform the one or more earthmoving operations at the worksite 132. The instruction file may be transmitted to the work machines that are required to perform the earthmoving operations. From the blocks 414, 416, the process 400 moves to a block 418 at which the process 400 terminates or ends operation.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the generation of the cost estimate to perform the one or more earthmoving operations at the worksite 132. The present disclosure also relates to the generation of the instruction file to autonomously perform the one or more earthmoving operations at the worksite 132. It should be noted that the teachings of the present disclosure may be applied to generation of cost estimates for a variety of applications including, but not limited to, autonomous construction of three-dimensional structures.

The cost estimate and the instruction file is generated by the controller 124. The cost estimate is transmitted to the user interface 102 and displayed on the user interface 102 for notifying the user regarding the cost estimate. Further, the instruction file is transmitted to the work machines. The instruction file is in the predefined format. The predefined format may allow the work machines to process the instruction file to autonomously perform the one or more earthmoving operations at the worksite 132.

The controller 124 takes into consideration various factors to generate the cost estimate and the instruction file. Specifically, the controller 124 considers the weight and the perimeter 134 of the structure 130 that is to be built at the worksite 132. As the weight and the perimeter 134 of the structure 130 have a direct impact on the efforts required to prepare the worksite 132, the consideration of such factors may increase an accuracy of the cost estimate and may improve system reliability.

The controller 124 also considers the geographical data, i.e., the latitude and longitude of the worksite 132. Further, the controller 124 also considers various operational variables that are dependent on the geographical data of the worksite 132. Such operational variables include, but are not limited to, the terrain at the worksite 132, the frost depth at the worksite 132, the elevation at the worksite 132, the vegetation at the worksite 132, the contractors that operate proximal to the worksite 132, the machine dealers that operate proximal to the worksite 132, and the cost corresponding to the previously concluded earthmoving operations proximal to the worksite 132. Further, the controller 124 also takes into consideration the types and sizes of work machines that will be required to perform the earthmoving operations based on the structure 130 selected by the user. As the operational variables at the worksite 132 have a direct impact on the efforts required to prepare the worksite 132, the consideration of the operational variables may increase the accuracy of the cost estimate and may improve system reliability.

Thus, the present disclosure relates to a computer platform and a tool for generating the cost estimate and the instruction file for preparing the worksite 132. Specifically, the controller 124 functions as an instant earthmoving cost estimate generation engine that may create real-time options for users to select/purchase earthmoving services. The cost estimate and the instruction file generated by the controller 124 may reduce time and efforts spent by the user. Further, the display on the user interface 102 also includes the break-up of costs and the time required for each earthmoving operation, which may simplify decision making for users. Further, users may select the complete package or individual earthmoving operations, as per their requirement. Overall, the present disclosure may provide up to date information of costs associated with various earthmoving operations at the worksite 132, which may improve decision making and reduce efforts required in calculation of costs for the earthmoving operations.

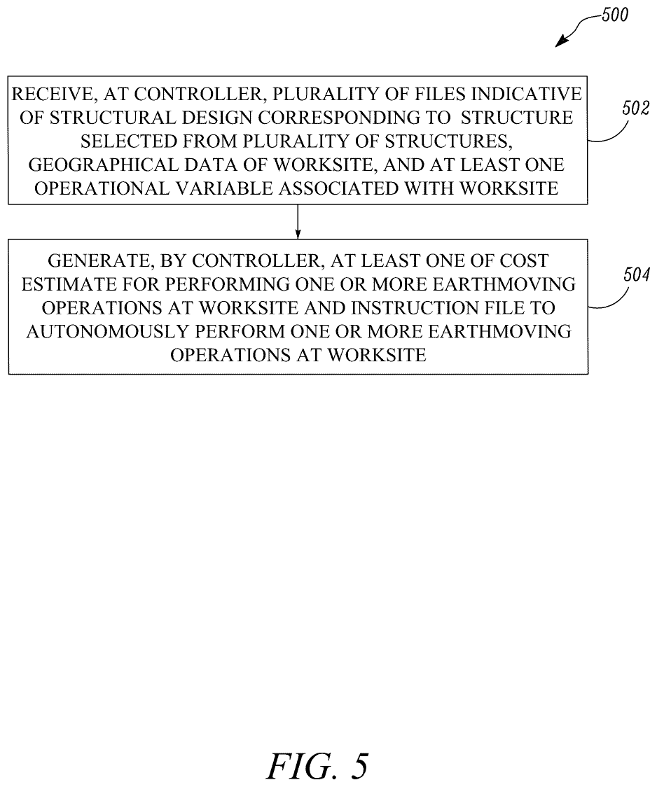

FIG. 5 is a flowchart for a method 500 of generating the cost estimate for performing the one or more earthmoving operations at the worksite 132. At a step 502, the controller 124 receives the number of files indicative of the structural design corresponding to the structure 130 selected from the number of structures, the geographical data of the worksite 132, and the one or more operational variables associated with the worksite 132. The one or more operational variables varies based on the geographical data of the worksite 132.

The structure 130 is manufactured by the additive manufacturing process. Further, the structural design of the structure 130 includes the perimeter 134 of the structure 130 and the weight of the structure 130. Furthermore, the geographical data of the worksite 132 includes the latitude and the longitude of the worksite 132. Moreover, the one or more operational variables associated with the worksite 132 includes the cost criterion, the terrain at the worksite 132, and/or the one or more land conditions at the worksite 132.

The step 502 at which the controller 124 receives the number of files indicative of the one or more operational variables includes receiving the number of files from the GIS database 104, the satellite imagery database 106, the database 108 containing information of terrain at the worksite 132, the frost depth database 110, the elevation database 112, and/or the vegetation database 114, receiving the number of files from the database of work machines 116 having the capability to perform the one or more earthmoving operations, and/or receiving the number of files from the database of contractors 118 that operate proximal to the worksite 132, the database of machine dealers 120 that operate proximal to the worksite 132, and/or the cost database 122 corresponding to the number of previously concluded earthmoving operations proximal to the worksite 132.

The controller 124 corresponds to the network portal 128. The user accesses the network portal 128 to select the structure 130 from the number of structures and provide the geographical data of the worksite 132.

At a step 504, the controller 124 generates the cost estimate for performing the one or more earthmoving operations at the worksite 132 and/or the instruction file to autonomously perform the one or more earthmoving operations at the worksite 132. The cost estimate is calculated based at least on the structural design corresponding to the structure 130, the geographical data of the worksite 132, and the one or more operational variables associated with the worksite 132. The cost estimate is displayed to the user.

Further, the instruction file is in the predefined format. The predefined format enables processing of the instruction file to autonomously perform the one or more earthmoving operations at the worksite 132. Further, the one or more work machines process the instruction file to autonomously perform the one or more earthmoving operations at the worksite 132.

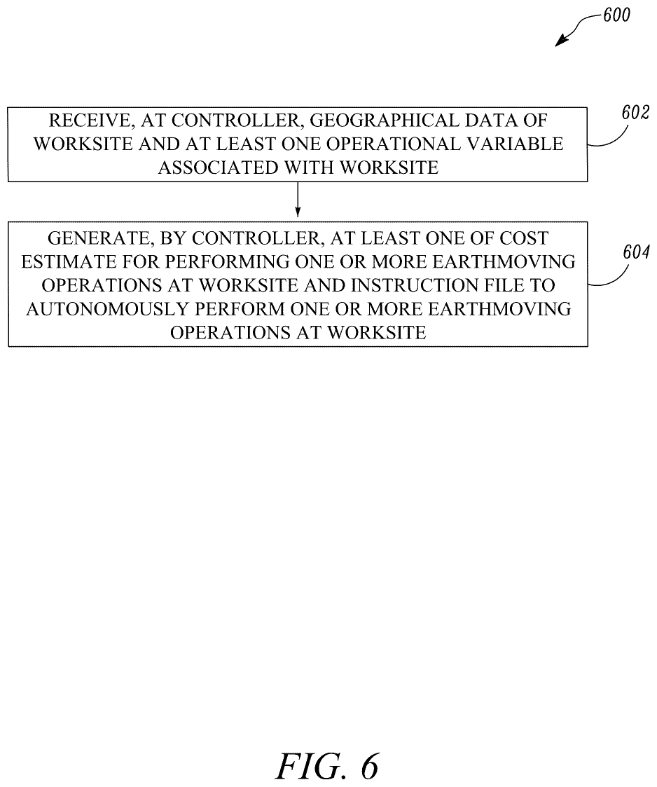

FIG. 6 is a flowchart for a method 600 of generating the cost estimate for performing the one or more earthmoving operations at the worksite 132 to autonomously construct the three-dimensional structure 130 at the worksite 132. The three-dimensional structure 130 is selectable from the number of files indicative of the structural design. At a step 602, the controller 124 receives the geographical data of the worksite 132 and the one or more operational variables associated with the worksite 132. The one or more operational variables varies based on the geographical data of the worksite 132.

The three-dimensional structure 130 is manufactured by the additive manufacturing process. Further, the structural design of the three-dimensional structure 130 includes the perimeter 134 of the three-dimensional structure 130 and the weight of the three-dimensional structure 130. Furthermore, the geographical data of the worksite 132 includes the latitude and the longitude of the worksite 132. Moreover, the one or more operational variables associated with the worksite 132 includes the cost criterion, the terrain at the worksite 132, and/or the one or more land conditions at the worksite 132.

The step 602 at which the controller 124 receives the number of files indicative of the one or more operational variables includes receiving the number of files from the GIS database 104, the satellite imagery database 106, the database 108 containing information of terrain at the worksite 132, the frost depth database 110, the elevation database 112, and/or the vegetation database 114, receiving the number of files from the database of work machines 116 having the capability to perform the one or more earthmoving operations, and/or receiving the number of files from the database of contractors 118 that operate proximal to the worksite 132, the database of machine dealers 120 that operate proximal to the worksite 132, and/or the cost database 122 corresponding to the number of previously concluded earthmoving operations proximal to the worksite 132.

At a step 604, the controller 124 generates the cost estimate for performing the one or more earthmoving operations at the worksite 132 and/or the instruction file to autonomously perform the one or more earthmoving operations at the worksite 132. The cost estimate is calculated based at least on the structural design corresponding to the three-dimensional structure 130, the geographical data of the worksite 132, and the one or more operational variables associated with the worksite 132. The cost estimate is displayed to the user.

Further, the instruction file is in the predefined format. The predefined format enables processing of the instruction file to autonomously perform the one or more earthmoving operations at the worksite 132. Further, the one or more work machines process the instruction file to autonomously perform the one or more earthmoving operations at the worksite 132.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

1. A method of performing one or more earthmoving operations at a worksite, the method comprising:
receiving, at a controller, a plurality of files indicative of a structural design corresponding to a structure selected from a plurality of structures, a geographical data of the worksite, and at least one operational variable associated with the worksite, wherein the at least one operational variable varies based on the geographical data of the worksite;
responsive to an input by a user to a user interface electronically selecting a complete package of earthmoving operations to be performed at the worksite toward building the selected structure;
generating, by the controller, both of:
a cost estimate for performing the complete package of earthmoving operations at the worksite, wherein the cost estimate is calculated based at least on the structural design corresponding to the structure, the geographical data of the worksite, and the at least one operational variable associated with the worksite, and wherein the cost estimate is displayed to the user, and
an instruction file to autonomously perform the complete package of earthmoving operations at the worksite;
displaying to the user the cost estimate on a display of the user interface accessible to the user; and
transmitting, using the controller, the instruction file to a plurality of work machines to autonomously perform the complete package of earthmoving operations at the worksite,
wherein the transmitted instruction file includes machine operation instructions for the plurality of work machines to autonomously perform the complete package of earthmoving operations at the worksite.

2. The method of claim 1,
wherein the controller corresponds to a network portal, and
wherein the user accesses the network portal to select the structure from the plurality of structures and provide the geographical data of the worksite.

3. The method of claim 1,
wherein the instruction file is in a predefined format,
wherein the predefined format enables processing of the instruction file to autonomously perform the complete package earthmoving operations at the worksite,
wherein the plurality of work machines are configured to process the instruction file to autonomously perform the complete package of earthmoving operations at the worksite, and
wherein the transmitted instruction file includes complete machine operation instructions for the plurality of work machines to autonomously perform the complete package of earthmoving operations at the worksite.

4. The method of claim 1, wherein the at least one operational variable associated with the worksite includes a cost criterion, a terrain at the worksite, and one or more land conditions at the worksite.

5. The method of claim 1, wherein the structural design of the structure includes a perimeter of the structure and a weight of the structure.

6. The method of claim 1, wherein the geographical data of the worksite includes a latitude and a longitude of the worksite.

7. The method of claim 1, wherein said receiving, at the controller, the plurality of files indicative of the at least one operational variable includes:
receiving the plurality of files from a geographical information system database, a satellite imagery database, a database containing information of terrain at the worksite, a frost depth database, an elevation database, and a vegetation database;
receiving the plurality of files from a database of work machines having a capability to perform the complete package of earthmoving operations; and
receiving the plurality of files from at least one of a database of contractors that operate proximal to the worksite, a database of machine dealers that operate proximal to the worksite, or a cost database corresponding to a plurality of previously concluded earthmoving operations proximal to the worksite.

8. The method of claim 1, wherein the structure is configured to be manufactured by an additive manufacturing process.

9. A non-transitory computer-readable storage medium having stored thereon instructions that, when executed by one or more processors, cause the one or more processors to perform a method comprising:
receiving, using circuitry, a plurality of files indicative of a structural design corresponding to a structure selected from a plurality of structures, a geographical data of the worksite, and at least one operational variable associated with the worksite, wherein the at least one operational variable varies based on the geographical data of the worksite;
responsive to an input by a user to a user interface, electronically selecting a package of earthmoving operations to be performed at the worksite toward building the selected structure;
generating, using the circuitry, both of:
a cost estimate for performing the one or more-package of earthmoving operations at the worksite, wherein the cost estimate is calculated based at least on the structural design corresponding to the structure, the geographical data of the worksite, and the at least one operational variable associated with the worksite, and wherein the cost estimate is displayed to a user, and
an instruction file to autonomously perform the package of earthmoving operations at the worksite;
displaying to the user, using the circuitry, the cost estimate on a display of the user interface accessible to the user; and
transmitting, using the circuitry, the instruction file to a plurality of work machines to autonomously perform the package of earthmoving operations at the worksite,
wherein the transmitted instruction file includes machine operation instructions for the plurality of work machines to autonomously perform the package of earthmoving operations at the worksite.

10. The non-transitory computer-readable storage medium of claim 9,
wherein the instruction file is in a predefined format,
wherein the predefined format enables processing of the instruction file to autonomously perform the package of earthmoving operations at the worksite, and
wherein the plurality of work machines are configured to process the instruction file to autonomously perform the package of earthmoving operations at the worksite.

11. The non-transitory computer-readable storage medium of claim 9, wherein the at least one operational variable associated with the worksite includes a cost criterion, a terrain at the worksite, and one or more land conditions at the worksite.

12. The non-transitory computer-readable storage medium of claim 9,
wherein the structural design of the structure includes a perimeter of the structure and a weight of the structure, and
wherein the geographical data of the worksite includes a latitude and a longitude of the worksite.

13. The non-transitory computer-readable storage medium of claim 9, wherein said receiving the plurality of files indicative of the at least one operational variable includes:
receiving the plurality of files from a geographical information system database, a satellite imagery database, a database containing information of terrain at the worksite, and an elevation database;
receiving the plurality of files from a database of work machines having a capability to perform the package of earthmoving operations; and
receiving the plurality of files from at least one of a database of contractors that operate proximal to the worksite, a database of machine dealers that operate proximal to the worksite, and a cost database corresponding to a plurality of previously concluded earthmoving operations proximal to the worksite.

14. The non-transitory computer-readable storage medium of claim 9, wherein the structure is configured to be manufactured by an additive manufacturing process.

15. A method of generating a cost estimate for performing one or more earthmoving operations at a worksite to autonomously construct a three-dimensional structure at the worksite, the three-dimensional structure being selectable from a plurality of files indicative of a structural design, the method comprising:
receiving, at a controller, a geographical data of the worksite and at least one operational variable associated with the worksite, wherein the at least one operational variable varies based on the geographical data of the worksite; and
responsive to an input by a user to a user interface, electronically selecting a complete package of earthmoving operations to be performed at the worksite toward creating the selected structure;
generating, by the controller, both of:
the cost estimate for performing the complete package of earthmoving operations at the worksite, wherein the cost estimate is calculated based at least on the structural design corresponding to the three-dimensional structure, the geographical data of the worksite, and the at least one operational variable associated with the worksite, and wherein the cost estimate is displayed to the user, and
an instruction file to autonomously perform the complete package of earthmoving operations at the worksite;
displaying to the user the cost estimate on a display of the user interface accessible to the user; and
transmitting, using the controller, the instruction file to a plurality of work machines to autonomously perform the complete package of earthmoving operations at the worksite,
wherein the transmitted instruction file includes machine operation instructions for the plurality of work machines to autonomously perform the complete package of earthmoving operations at the worksite.

16. The method of claim 15,
wherein the instruction file is in a predefined format,
wherein the predefined format enables processing of the instruction file to autonomously perform the complete package of earthmoving operations at the worksite, and
wherein plurality of work machines are configured to process the instruction file to autonomously perform the complete package of earthmoving operations at the worksite.

17. The method of claim 15, wherein the at least one operational variable associated with the worksite includes at least one of a cost criterion, a terrain at the worksite, or one or more land conditions at the worksite.

18. The method of claim 15,
wherein the structural design of the three-dimensional structure includes a perimeter of the three-dimensional structure and a weight of the three-dimensional structure, and
wherein the geographical data of the worksite includes a latitude and a longitude of the worksite.

19. The method of claim 15, wherein said receiving, at the controller, the plurality of files indicative of the at least one operational variable includes:
receiving the plurality of files from a geographical information system database, a satellite imagery database, and a database containing information of terrain at the worksite;
receiving the plurality of files from a database of work machines having a capability to perform the complete package of earthmoving operations; and
receiving the plurality of files from at least one of a database of contractors that operate proximal to the worksite, a database of machine dealers that operate proximal to the worksite, or a cost database corresponding to a plurality of previously concluded earthmoving operations proximal to the worksite.

20. The method of claim 15, wherein the three-dimensional structure is configured to be manufactured by an additive manufacturing process.
